(19) United States
(12) Patent Application Publication
(10) Pub. No.: US 2014/0280072 A1
(43) Pub. Date: Sep. 18, 2014

(54) Method and Apparatus for Human-Machine Interaction

(71) Applicant: Advanced Search Laboratories, lnc., Allen, TX (US)

(72) Inventor: Jason Coleman, Cedar Point, TX (US)

(73) Assignee: Advanced Search Laboratories, lnc., Allen, TX (US)

(21) Appl. No.: 14/209,490

(22) Filed: Mar. 13, 2014

Related U.S. Application Data
(60) Provisional application No. 61/781,442, filed on Mar. 14, 2013.
(60) Provisional application No. 61/781,621, filed on Mar. 14, 2013.

(51) Int. Cl. G06F 17/30

(52) U.S. Cl. CPC G06F 17/30277; G06F 17/30554
USPC 707/722

(57) ABSTRACT

Systems and methods are provided for enabling the creation and generation of complex forms for machine-human interaction with minimal cognitive load on the user by providing a mechanism of inference and application of the intent or state of a given value into an input object that is otherwise stateless or without intent.

### CLAIM OF PRIORITY AND CROSS-REFERENCE TO RELATED APPLICATIONS

The present application is related to U.S. Provisional Patent Application No. 61/781,442 filed Mar. 14, 2013, entitled “Complex form Streamlining Method and Apparatus for Human Interaction,” and to U.S. Provisional Patent Application No. 61/781,621, filed Mar. 14, 2013, entitled “Encoded System for Dimensional Related Human Machine Interaction.” The present application hereby claims priority under 35 U.S.C. §119(e) to U.S. Provisional Patent Application No. 61/781,442 and to U.S. Provisional Patent Application No. 61/781,621.

### TECHNICAL FIELD

The invention relates generally to human-machine interactions and database storage, retrieval and artifact representation in a machine readable medium, and is also generally related to U.S. Class 707.

### SUMMARY

Example embodiments are related to systems and methods for human-machine interaction, specifically forms, screens and other user interface (UI) implementations that are designed to enable a user to provide or be queried for information. At least some embodiments specifically addresses the problem of the high cognitive load associated with large and complex forms (e.g., an advanced search form), or for forms where there is a high ratio of possible inputs to required inputs. At least some embodiments utilize the data input into a generic, stateless, or semi-generic input object to infer the intent of the input value from the user. That inference may then be communicated back to the user, providing them with an opportunity to alter or correct the value of the inference. Simply put, at least some embodiments enable forms to be simpler, shorter and more elegant (i.e., require a lower cognitive load) and provide affordances on an as-needed basis as opposed to an all-at-once basis.

One example is a set of methods that include: a process for enabling the utilization of the precise minimum of fields from a potentially much larger possible number of fields to capture a user's intended input; a process for adapting the intent of each enabled field to dynamically react to the specific input provided; a process for modifying the role of a given field within a form on the basis of the input provided; and a process for altering the presentation of input objects on the basis of the provided input they contain.

Another example is a system that includes a set of modules having one or more processors programmed to execute software code retrieved from a computer readable storage medium containing software processes. This system is embodied as a set of process and UI modules including: modules for enabling the utilization of the precise minimum of fields from a potentially much larger possible number of fields to capture a user's intended input; modules for adapting the intent of each enabled field to dynamically react to the specific input provided; modules for modifying the role of a given field within a form on the basis of the input provided; and modules for altering the presentation of input objects on the basis of the provided input they contain.

Another example is a system or apparatus that includes a set of modules or objects having one or more processors programmed to execute software code retrieved from a computer readable storage medium containing software processes. This system or apparatus is embodied as a set of process and UI modules and display objects contained within a presentation space, including: modules for enabling the utilization of the precise minimum of fields from a potentially much larger possible number of fields to capture a user's intended input; modules for adapting the intent of each enabled field to dynamically react to the specific input provided; and modules for modifying the role of a given field within a form on the basis of the input provided; modules for altering the presentation of input objects on the basis of the provided input they contain.

### BRIEF DESCRIPTION OF THE DRAWINGS

The objects, features, and advantages of the examples described in this application will be apparent from the following more particular description of preferred embodiments as illustrated in the accompanying drawings, in which reference characters refer to the same parts throughout the various views. The drawings are not necessarily to scale, emphasis instead being placed upon illustrating principles of the disclosure.

FIG. 1 is a flow chart in accordance with an example embodiment;

FIG. 2 is a flow chart in accordance with an example embodiment;

FIG. 3 is a flow chart in accordance with an example embodiment;

FIG. 4 is a software code listing in accordance with an example embodiment; and

FIG. 5 is a software code listing in accordance with an example embodiment.

### DETAILED DESCRIPTION

### Graphical Symbols and Elements

Graphical symbols and elements in the drawings generally have the following meanings in this application.

1. Octagons, i.e. rectangles with clipped corners, represent an interaction with the other system components and a system controller responsible for managing activity traffic.

2. Rectangles with rounded corners represent some processing or execution of logic within the system, a software module or software component, that may or may not require human interaction.

3. Rectangles without rounded corners represent an artifact or data record, or a subset of an artifact or data record.

4. Cylinders (i.e., rectangles overlaid with an oval at the top) represent a data store.

5. Lozenges (or diamonds) (e.g., rhombus) represents one of one or more decision paths.

6. Unidirectional Lines (i.e., lines with no decoration or a square at one end point and an arrow at the other end point) and Bidirectional Lines (i.e., lines with an arrow at both end points) represent a logical flow of activities between two components of the process being illustrated; these activities include but are not limited to messages, data and transfer of control.

7. Lines without direction indicia (i.e., lines with no additional characteristics at either end) represent a general association between artifacts and/or data records.

8. All lines, regardless of end point decorations or characteristics, with one or more right angle bends and no spatial gaps are considered single lines with end points identified at the touch points to one of the graphical symbols or elements defined previously.

The figures are not formal logic flow charts and are not intended to represent the various conditional tests and repetitions that can and will occur in any particular example or embodiment. Rather, they are intended to illustrate the principles and logical components of example embodiments.

### Overview

Various embodiments relate to many Web-based and computer based applications, including, but not limited to search, social network applications and information retrieval processes that support these applications. Searching for information or specific artifacts that contain information or other resources on the basis of identifying characteristics, whether on the web or on some other electronic device (e.g., computer or smartphone), is, for most people, a daily activity. The extension and enhancement of human knowledge and net intelligence fostered by the development and growth of this kind of activity may be rivaled only by the invention of the printing press or of written communication itself. The core processes that make this kind of activity possible are best referred to by the term “Information Retrieval.” Similarly, a large number of people and organizations create, collect, tag and distribute private and public information via social networks. The utility of such systems as information networks operating as objective sources of truth regarding general information is debatable. However, when information residing in these systems is cast as term facet characteristics that transparently expose the source and subjectivity of source, such systems can become powerful resources for profoundly rich and complex apparatuses of extending human intelligence, collective or individual memory, social knowledge and accessible information. Further, individuals may similarly create, tag, collect and distribute information for personal or shared use in the same manner with similar results and applications.

Certain definitions apply to certain embodiments as follows.

“Information Retrieval”—(IR) is a field, the purpose of which is the assembly of evidence about information and the provision of tools to access, understand, interact with or use that evidence. It is concerned with the capture, structure, analysis, organization and storage of information. It can be used to locate artifacts in order to access the information contained therein or to discover abstract or ad-hoc information independent of artifacts.

“IR System”—An IR System is one or more software modules, stored on a computer readable medium, along with data assets stored on a computer readable medium that, in concert perform the tasks necessary to perform information retrieval.

“Information” denotes any sequence of symbols that can be interpreted as a message.

“Artifact” denotes any discrete container of information. Examples include a text document or file (e.g., a TXT file, ASCII file, or HTML file), a rich media document or file (e.g., audio, video, or image, such as a PNG file), a text-rich media hybrid (e.g., Adobe PDF, Microsoft Word document, or styled HTML page), a presentation of one or more database records (e.g., a SQL query response, or such a response in a Web or other presentation such as a PHP page), a specific database record or column, or any such machine-accessible object that contains information. The above list includes artifacts that are accessible by information technology. By extrapolation artifacts can include reference to or meta-information about, regarding or describing physical objects, people, places, concepts, ideas or memes. Additional examples, in various embodiments could also include references to domains or subdomains, defined collections of other artifacts, or references to real world objects or places. While information technology systems provide reference to or presentations of these references, descriptions of the use process often conflates the reference artifact and the actual artifact. Such conflations should be interpreted referentially; in context to a process or apparatus as a reference; in context to a human being as the actual artifact, except whereas denoted as a representation of a term characteristic, facet presentation or other UI abstraction.

“Ad Hoc Information” denotes types of information that are represented as, or can be demonstrated to be, true, independently of a specific single source artifact. This comprises information about information (e.g., the query entered returned n number of results) that is a result for a query for information and may not reside in any discrete artifact prior to interaction with an IR system. (Though, of course, such information could have been created by identical prior queries and cached in an artifact.). This can also describe information that is derived from other information, or from a large set of distinct artifacts and can be said to be generally true based on that evidence; an observable fact that can be derived from observing one or more artifacts that may or may not be explicitly contained within the target artifact(s).

“Abstract Information” denotes information that is represented, or can be demonstrated to be true, independently of a specific single source artifact. This includes mathematical assertions (e.g., 5=10/2) or any statement that can be asserted as corresponding to reality, independent of a source artifact. In an IR context such information is almost exclusively a construct of user perception and intent. In operation of a given IR apparatus queries for such information almost exclusively rely on a source artifact. While this may seem to be a pointless semantic distinction, it is important for interpreting many expressions regarding user intent.

“Structure” denotes that IR must include processes that address information that exists in a variety of forms; structured, unstructured or heterogeneous (e.g., a database record with fields or a text document with text content or a multimedia document with both).

“Analysis” denotes that IR must necessarily include processes that analyze the component characteristics of information; these include, but are not limited to context (including but not limited to location, internal citations and external citations), meta-characteristics (including but not limited to publish date, author, source, format, and version), terminology (including but not limited to term inclusion, term counts, and term vectors), format (physical and/or objective), empirical classification or knowledge discovery (i.e., machine learning: artificial intelligence analysis that leads to categorizing a given artifact as belonging to one or more classes, typically part of a systematic ontology, processes usually represented by one or more of Clustering, SVM, Bayesian Inference, or similar).

“Organization” denotes that IR must address the manner in which information is organized, both in the source artifact and in the storage of a resulting index; this is necessary to address the physical necessities of observing the contents of artifacts, the physical necessities of storing information about those artifacts as well as the underlying philosophies that guide both.

“Storage” denotes that all artifacts that contain information and all indexes that contain information about artifacts must be physically stored in a medium. That medium will have rules, capabilities and limitations that must be part of the consideration of all IR processes. This includes, but is not limited to databases (e.g., SQL), hypertext documents (e.g., HTML), text files (e.g., PDF; .DOCX), rich media (e.g., .PNG; .MP4). Storage also denotes that the IR process itself must store information about the artifacts it addresses (e.g., an index or cache).

“Evidence” denotes information about information that is used as an input or feedback within the IR system. Evidence may be used transparently represented to the user within the UI, or invisibly, hidden from perception by the user. A query can be said to be comprised of components defining the evidence requirements for a desired result. Evidence is also a collection of characteristics that describe a result. Results that have the highest correspondence to a query's information need are the most relevant. The most relevant results are, ideally, the most useful in meeting the user's intent in searching for information, but this is not always the case. Usually, this is because of an imperfect correlation with the expression of a query with a user's actual intent. For most IR systems, even the best formed query is at best an imperfect simplification of the actual user intent. This can occur for a number of reasons, including lack of understanding the manner in which the IR system operates, semantic error, too much ambiguity, too little ambiguity, and other reasons. If all other aspects are equal, IR systems that achieve a higher degree of correlation between user intent and query input will produce better results, greater user satisfaction and competitive advantage. “Evidence” may, in many contexts, be synonymous with the terms “signals,” “data,” and even “information.” Correlation between the evidence described in a query and evidence recorded in relation to a given artifact are the primary determinant of relevance (or “base relevance”). In many contexts and embodiments, “evidence” can also include a representation of the artifact that is the subject of the total evidence set. This representation may be a literal copy, stored in a given location, or may be tokenized, compressed, or otherwise altered for storage and/or efficiency purposes.

“Tools” denotes the interactive apparatus of the system, primarily the user interface (UI), but also includes the underlying components, processes and interconnected systems that enable the user to interact with the IR system and the concepts and ideas that drive it as well as the component facets, categories or other characteristics that impart structure and organization to the manner in which evidence, results and artifacts are accepted, assembled and presented by the IR system.

The ultimate purpose of IR is usability by and accessibility for human beings, even if that usability is several steps removed from presentation to a human user. Evidence generated (retrieved, observed, collected, predicted, tagged or classed) by IR systems is composed of fallible interpretations of the source artifact and fallible organization of evidence in the form of ontologies or other categorical structures. It would be a false assertion to claim that any representation of a source artifact stored by an IR process is not in some manner distorted, even if that distortion is one of context alone. These distortions are a necessary part of an IR process. Many of the resulting qualities of distortion are positive (e.g., processing efficiency), but others may not be desirable (e.g., distortion of relevancy). An IR system that fails to address usability by and accessibility for human beings will only partially meet its potential value as a tool. If the utility of an IR system is not consumable by a human being it is irrelevant. By extension, the more consumable utility provided, the more valuable the system. Every IR system, through its structure, organization and user experience imparts and projects a particular world view and philosophy about the nature of information it addresses. This is a necessary part of an IR process, as information without organization and context is merely unusable data. Maintaining transparency to and even configurability of this world view increases the flexibility, usability, scalability and value of an IR system.

### Information Need

Information Need is the underlying impetus that drives a user to interact with an IR system. The primary interaction with an IR system is the query. Queries are most often some form of structured or unstructured string (text) input. Even in cases where queries are driven by complex rich media constructs (such as speech-to-text, chromatic or other processes) terms are almost always reduced or translated into string inputs. A truism of “search engine—user interaction” is that queries are usually a poor representation of what the user wants, and of the information need that drives it.

A number of techniques and processes have been developed to assist users to assemble, refine or correct queries so that they better express what the user wants. These include query suggestion, query expansion, term disambiguation hinting, term meaning expansion, polysemic disambiguation, monymic disambiguation and relevance feedback.

It is a common misconception among users that IR systems (search engines) are objectively truthful. The user typically believes the search engine is a means by which they can find accurate information. But, there is an increasing trend to view search engines with greater suspicion; a growing awareness that search engines distort results. Examples of such distortions occur in the IR marketplace, and can be both intentional and unintentional. In this environment, providing transparency to the process and organization of search are generally desirable in IR systems.

### Information Conveyance

Retrieval of information by the IR system (capture) is a distinctly different process from retrieval of information by the user (access). While these processes are closely related in the context of IR, they rely on two completely unrelated primary operators—a computer (or similar machine, or collection of similar machines) and a human being, respectively. IR is ultimately about facilitating access to information by the human being. One way to express this is that an IR system is an apparatus that conveys information from a collection of sources to a human being. There are at least four types of information conveyance that can occur in the usage of an IR system. These are:

1. Directed access to an artifact;

2. Education about an artifact;

3. Education about the perceived meaning of evidence input (terms, etc.); and

4. Information or inference about the organization of evidence in the IR system.

“Directed access to an artifact” means providing a hyperlink, directions, physical address or other means of access to or representation of an artifact.

“Education about an artifact” means, through the user interface of the IR system, providing the user with information about an artifact that appear in search results (e.g., where the artifact is located, the title of the artifact, the author of the artifact, the date the artifact was created, the context of the artifact, an abstract or description of the artifact or other similar information). This can also denote information about how the artifact is interpreted by the IR system, including but not limited to evidence and specific characteristics of evidence regarding the artifact (e.g., the most relevant terms or tags for the document outside the context of the current query, or those within the context of the query). This may include various forms of ad-hoc or abstract information.

“Education about the perceived meaning of evidence input” means, through the user interface of the IR system, providing the user with information about terms or concepts that were either entered by the user, or may be relevant to the terms entered by the user. This may include a list of related terms, an encyclopedia-like text description of the meaning of the a given concept associated with the input, images or other multimedia content, or a list of possible interpretations of terms aimed at achieving disambiguation for polysemic terms. This may include various forms of ad-hoc or abstract information.

“Information or inference about the organization of evidence in the IR system” means providing the user with information or inferences about how information may best be located using the IR system, with the tools that it provides or enables. A simple and common example of this kind of education occurs when, on most major search engines if a user enters the term “fortune 500 logos” a result similar to “images for fortune 500 logos” which is a link to a vertical categorical search for the same terms. This prompts the user to interact with the system in a different manner and implies a more efficient use of the system in the future. Enabling these kinds of inferences on the part of the user enables them to make more insightful and efficient searches in the future. IR systems that actively promote these inferences and the work to expose the user to the characteristics of the IR systems world view, organization and philosophy can achieve higher quality interactions and results than those that do not. This may include various forms of ad-hoc or abstract information.

Ideally, the UI of an IR system presents the information of each of these forms of conveyance in a manner that informs, educates and motivates the user about the system to enable increased performance in current and future use. A system that achieves aspects of this ideal should obtain competitive advantage against systems that do not.

### Specificity

In most extant IR systems, quality is typically measured solely on the response of the IR system to queries. However, superior user experiences and qualitative outcomes are achievable in systems that also apply measures of quality to input; input being the totality of terms and term qualifiers entered by the user and/or inferred by the system. For purposes of this disclosure the term “Specificity” is used to describe the general quality of inputs by the user, which may or may not include refinements, inferences and disambiguations provided by the IR system. Input terms or queries with greater specificity can be said to be of higher quality than those of lower specificity. It is thus desirable for IR systems to produce, foster, inculcate, encourage or produce through user interaction, user experience methodologies or inference methodologies queries of greater specificity.

However, like relevance, specificity is best measured directly against the information need of the user. Such measures cannot always be directly and objectively derived by observation, though they can be inferred. In this sense it can be said that the greater the correlation between the user's information need and the systems interpretation of query and terms the higher the specificity of the query or terms.

The terms “term” and/or “input terms” are typically defined in relation to IR systems as the information (usually but not always written—also including but not limited to spoken, recorded or artificially generated speech, braille terminals, refreshable braille displays or other sensory input and output devices capable of supporting the communication of information) that is provided to the system by the user that comprises the query. For the purposes of this disclosure these terms should be understood to be expanded beyond their customary meaning to also include a variety of additional meta-data that accompanies and complements the user input information. This additional information provides additional specificity to the query in that it can include (though is not limited to) dimensional data, facet casting data, disambiguation data, contextual data, contextual inference data and other inference data. This additional information may have been directly or manually entered by the user, may have been invisible to the user, or may have been implicitly or tacitly acknowledged by the user. Data about how the user has interacted with the terms to arrive at the complete set of meta-data can also be included in some embodiments.

For the purposes of this disclosure, the term “dimension,” “search dimension” or “facet” in relation to a term or artifact evidence connotes a categorical isolation of the term or artifact in its use and interpretation by the IR system to a particular category or ontological class or subclass. Dimensionality can be applied to any number of kinds of categorical schemas, both fixed or dynamic and permanent or ad-hoc. Both fixed ontologies (taxonomies) and variable ontologies can be applied as dimensions and can be implemented at various levels of class-subclass depth and complexity. In some embodiments and processes dimensionality may refer to an exclusive categorization of an artifact, term or characteristic. In other embodiments categorizations are not exclusive and may be weighted, include a number of dimensional references and/or include a number of dimensional references with variable relative weights. For example, in at least one embodiment, a simple ontology may divide all artifacts into two classes: “fiction” and “non-fiction.” In this embodiment if an artifact belongs to the “fiction” class it cannot belong to the “non-fiction” class. In another embodiment all artifacts may sort all artifacts into two classes “true” and “untrue” with each artifact being assigned a relative weight on a specific generalized scale (e.g., 0 to 100, with 100 being the highest and 0 being the lowest rating) for each class, so that a given artifact might have a 20 “true” weight and an 80 “untrue” weight. Generalized scales may be zero-sum, or non-zero sum, for these purposes. In still other embodiments, multiple ontologies or schemas could be combined. For example the “fiction/non-fiction” and “true/untrue” ontologies could be combined into a single IR system that exposes and enables searching for all four dimensions.

For the purposes of this disclosure, the term “dimensional data” in relation to a term or query should be defined as an association between a term and a collection of information that defines a dimensional interpretation of that term. In some embodiments this may include references to logical distinctions, association qualifiers, or other variations and combinations of such. or example, term “London” could be said to be associated with the dimension “place.” Further, term “London” could also be said to be 90% associated with the dimension “place” and 10% associated with the dimension “individual:surname.” Further, through inference or manual user interaction, these weightings could be altered, or even removed. Further, through inference or manual user interaction, an association could be modified to a Boolean “NOT.” Further, through inference or manual user interaction, one or more terms could be associated as a set as collectively “AND” or collectively “OR.” One adequately skilled in the art can, of course, anticipate and apply numerous further logical iterations and variations on this theme.

For the purposes of this disclosure, the term “facet casting” or “dimension(al) casting” in relation to a term or result indicates that a particular term has been either manually or automatically defined as targeting a specific search dimension. In some cases this may be synonymous with dimensional data in that it describes term meta-data related to dimensional definitions. Unlike dimensional data, in some embodiments facet casting includes no connotation of weighting or exclusivity. For example, in one embodiment, the term “Washington” could be cast in the dimension of “place” indicating that it is focused on geography or map information. Alternatively “Washington” could be cast in the dimension of “person” indicating that is focused on biographical or similar information. Whereas dimensionality is an evolution of prior extant ideas (though not contained in those ideas) in the field regarding faceting, the term “dimensional casting” may be preferred, as “facet casting” may be, in some contexts, confused as to be limiting to the bounds of the traditional meaning of “facet.” In this disclosure any usage of the term “facet casting” or facet should be interpreted to include the broader meanings of “dimension” and “dimensional casting.”

For the purposes of this disclosure, the term “disambiguation data” in relation to a term, query or result set connotes information that is intended to exclude overly broad interpretations of specific terms. For example, a common ambiguity encountered by IR systems is polysemy or homonymy. In one embodiment disambiguation data indicates one specific meaning or entity that is targeted by a term. For example, it may indicate that the term “milk” means the noun describing a fluid or beverage rather than the verb meaning “to extract.” In other embodiments this data may comprise information that defines one or more specific levels, contexts, classes or subclasses in an ontology or variable ontology. For example the term “milk” may be specified to mean the “beverage” subclass of a variable ontology, while simultaneously being indicated to mean the “fluid” subclass of the same variable ontology, while being indicated to mean the class “noun” (the parent class of fluid and beverage), while being excluded from the class “verb.” Similarly, this data may span multiple ontologies, category schemas or variable ontologies. For example, in the previous example, the term milk could also be indicated to belong to the class “product” in a second unrelated ontology as well as being categorized as “direct user entry” in a third categorization schema.

For the purposes of this disclosure, the term “polysemy” connotes terms that have the capacity for multiple meanings or that have a large number of possible semantic interpretations. For example the word “book” can be interpreted as a verb meaning to make an action (to “book” a hotel room) or as a noun meaning a bound collection of pages, or as a noun meaning a text collected and distributed in any form. Polysemy is distinct, though related to, homonymy.

For the purposes of this disclosure, the term “homonymy” connotes words that have the same construction and pronunciation but multiple meanings. For example, the term “left” can mean “departed,” the past tense of leave, or the direction opposite “right.”

For the purposes of this disclosure, the term “stop word” connotes words that occur so frequently in language that they are usually not very useful. For example, in many IR systems the word “the” as a search term is largely not useful for generating any meaningful results.

For the purposes of this disclosure, the term “contextual data” in relation to a term or query connotes meta data that describes the context in which the query was entered into the system. In some embodiments, this may comprise, but is not limited to: demographic or account information about the user; information about how the user entered the UI of the system; information about other searches the user has conducted; information about other previous user interactions with the system; the time of day; the geolocation of the user; the “home” geolocation of the user; information about groups, networks or other contextual constructs to which the user belongs; and previous disambiguation interactions of the user. In most embodiments, this will be information that is stored chronologically separately from the interactions in which the query was formed.

For the purposes of this disclosure, the term “contextual inference data” in relation to a term or query connotes meta-data that describes the context in which the query was entered into the system. In some embodiments this can include all of the information described for contextual data, but also includes: information disambiguating the meaning of terms derived from semantic analysis or word context among the terms, plurality or subset of terms. In general contextual inference data differs from contextual data in that it is usually inferred from observation of the “current” or recent user interactions with the system.

### Dimensional Articulation

Higher degrees of specificity can be accomplished in IR systems by increasing the degree of “dimensional articulation” or simply “articulation,” which, for the purposes of this disclosure connotes the degree to which terms have been contextually packaged with information that describes their relationship to, inclusion from or inclusion within search facets or search dimensions. This can be said to describe both the data stored about terms within the system, whether or not it is exposed to the user, and it can also be used to describe the degree to which this information is exposed to the user via the user interface. Additionally, this can be used to describe the degree to which artifacts collected within the system have been associated with one or more dimensions. The association of an artifact with a dimension, can, within the context of some IR systems be referred to as “tagging.” For example a given IR system could be described as being highly dimensionally articulated in its analysis of terms for producing query results, but having low dimensional articulation in its user interface. In either case, in many embodiments, the functional realization of that depth of articulation may be dependent upon the degree to which the artifacts are dimensionally articulated (tagged or associated with one or more dimensions).

For the purposes of this disclosure, the term “fixed articulation” or “fixed” in reference to a term's dimensional articulation, especially, though not exclusively to its exposure in the UI of the IR system connotes dimensional articulation that is characterized, in various embodiments, by at least one of the following or similar: applied to only one dimension; applied to only a single class or subclass of a dimensional ontology (fixed or variable); provides a very limited number of value options; includes or uses terms that can only be applied to one or few dimensions; does not permit the transference of a term from one dimension to another; in any other way does not conform to the connotations of flexible articulation; and, in some embodiments do not (or do not clearly) expose to the user the manner in which the term's dimensionality is articulated.

For the purposes of this disclosure, the terms “variable articulation” or “flexible articulation” in reference to a term connote an IR system and/or IR system user interface that includes some or all of the following: facet term linking; dimensional mutability; facet weighting; dimensional intersection; dimensional exclusion; contextual facet casting; facet inference; facet hinting; facet exposure; manual facet interaction; facet polyschema; and facet Boolean logic. An IR system that exhibits several or all of these characteristics can be said to have high dimensional articulation and to have a high degree of specificity.

For the purposes of this disclosure, the term “facet term linking” (or “dimensional term linking”) connotes a form of dimensional articulation in which search terms have one or more association with a search dimension. This enables terms to express greater specificity within a search query and to provide more powerful information need correlation. This enables the IR system to provide improved information conveyance to the user and to improve specificity and information need correlation.

For the purposes of this disclosure, the term “dimensional mutability” connotes a form of dimensional articulation in which search terms may manually or automatically have their association with a search dimension changed to a different or a null association. This enables the quick translation, correction, disambiguation or alteration of a term from one dimension to another. This enables the IR system to provide improved information conveyance to the user and to improve specificity and information need correlation.

For the purposes of this disclosure, the term “facet weighting” (or “dimensional weighting”) connotes a form of dimensional articulation in which a search term's dimensional association(s) may also be associated with a particular relative or absolute weight. Any number of generic or scaled weights may be used. This enables the IR system to improve specificity and information need correlation.

For the purposes of this disclosure, the term “dimensional intersection” connotes a form of dimensional articulation in which search terms with dimensional data may be combined as terms within a single query so that each included term is collectively associated with a Boolean “AND;” this could also be described as a conjunctive association or simply as conjunction. This enables terms to express an information need that spans two or more verticals or dimensions in a single search query and to improve specificity and information need correlation.

For the purposes of this disclosure, the term “dimensional exclusion” connotes a form of dimensional articulation in which search terms with dimensional associations may be associated with a Boolean “NOT;” this could also be described as a negative association or negation. Such terms act as negative influences for relevance returns. This enables terms to specifically express the exclusion of artifact evidence that corresponds to the term and to improve specificity and information need correlation.

For the purposes of this disclosure, the term “contextual facet casting” (or “contextual dimensional casting”) connotes a form of dimensional articulation in which the terms and implicit or tacit dimensional association of terms in the query or a subsection of the query may influence the manner in which the facet inference or facet hinting occurs. This enables the IR system to provide improved information conveyance to the user and to improve specificity and information need correlation.

For the purposes of this disclosure, the term “facet inference” (or “dimensional inference”) connotes a form of dimensional articulation in which search terms entered into a query are analyzed by the IR system and automatically cast or hinted for casting in the most likely inferred dimension(s). This enables the IR system to provide improved information conveyance to the user and to improve specificity and information need correlation.

For the purposes of this disclosure, the term “facet exposure” (or “dimensional exposure”) connotes a form of dimensional articulation in which search terms with dimensional association(s) have those associations exposed to the user. This enables the IR system to provide improved information conveyance to the user and to improve specificity and information need correlation.

For the purposes of this disclosure, the term “facet hinting” (or “dimensional hinting”) connotes a form of dimensional articulation in which suggested search dimension associations are displayed for each term in the query and which the user may interact with tacitly or implicitly to approve, accept or modify the suggested casting. This enables the IR system to provide improved information conveyance to the user and to improve specificity and information need correlation.

For the purposes of this disclosure the term “manual facet interaction” (or “manual dimensional interaction”) connotes a form of dimensional articulation in which the facet casting of search terms may be manually modified by the user of the IR system. This enables the IR system to improve specificity and information need correlation.

For the purposes of this disclosure, the term “facet polyschema” (or “dimensional polyschema”) connotes a form of dimensional articulation in which search terms may be cast across dimensions belonging to various organizational schemas within the same query. This enables the IR system to improve specificity and information need correlation.

For the purposes of this disclosure, the term “facet Boolean logic” (or “dimensional Boolean logic”) connotes a form of dimensional articulation in which the dimensional associations of search terms may also include associations with Boolean operators (conjunction (AND), disjunction (OR), or negation (NOT). This enables the IR system to improve specificity and information need correlation.

For the purpose of this disclosure, the term “set” connotes a collection of defined and distinct objects that can be considered an object unto itself.

For the purpose of this disclosure, the term “union” connotes a relationship between sets, which is the set of all objects that are members of any subject sets. For example, the union of two sets, A{1,2,3} and B{2,3,4} is the set {1,2,3,4}. The union of A and B can be expressed as “A B”.

For the purpose of this disclosure, the term “intersection” connotes a relationship between sets, which is the set of all objects that are members of all subject sets. For example, the intersection of two sets, A{1,2,3} and B{2,3,4} is the set {2,3}. The intersection of A and B can be expressed as “A B”.

For the purpose of this disclosure, the term “set difference” connotes a relationship between sets, which is the set of all members of one set that are not members of another set. For example, the set difference from set A{1,2,3} of set B{2,3,4} is the set {1}. Inversely, the set difference from set B{2,3,4} of set A{1,2,3} is the set {4}. The set difference from A of B can be expressed as “A \ B”. “Set difference” can be synonymous with the terms “complement” and “exclusion.”

For the purpose of this disclosure, the term “symmetric difference” connotes a relationship between sets, which is the set of all objects that are a member of exactly one of any subject sets. For example, the symmetric difference of two sets, A{1,2,3} and B{2,3,4}, is the set {1,4}. The set difference of sets A and B can be expressed as “(A B)\(A B).” “Symmetric difference” is synonymous with the term “mutual exclusion.”

For the purpose of this disclosure, the term “cartesian product” connotes a relationship between sets, which is the set of all possible ordered pairs from the subject sets (or sequences of n length, where n is the number of subject sets), where each entry is a member of its relative set. For example, the Cartesian product of two sets, A{1,2} and B{3,4} is the set ({1,3},{1,4},{2,3},{2,4}).

For the purpose of this disclosure, the term “power set” connotes a set whose members are all subsets of a subject set. For example, the power set of set A{1,2,3} is the set ({1},{2},{3},{1,2},{1,3},{2,3},{1,2,3}).

For the purpose of this disclosure, the terms “conjunctive” and “Boolean AND” connote the Boolean “AND” operator, connoting an operation on two logical input values which produces a true result value if and only if both logical input values are true. This is synonymous with the term “Boolean AND” and can be notated in a number of ways, including “ab,” “Kab”, “a && b” or “a and b.”

For the purpose of this disclosure, the terms “disjunctive” and “Boolean OR” connote the Boolean “OR” operator, connoting an operation on two logical input values which produces a false result value if and only if both logical input values are false. This is synonymous with the term “Boolean OR” and can be notated in a number of ways, including “ab,” “Aab”, “a∥b” or “a or b.”

For the purpose of this disclosure, the terms “negative” and “Boolean NOT” connote the Boolean “NOT” operator, connoting an operation on a single logical input value which produces a result value of true when the input value is false and a result value of false when the input value is true. This is synonymous with the concept of “negation” or “logical complement” and can be notated in a number of ways, including “ [symbol] a”, “!a”, “!a” or “not a”.

Search queries of greater specificity may be achieved by the utilization of various forms of organization of search dimensions. These are variously expressed in embodiments of the current invention as categories, schemas, ontologies, taxonomies, folksonomies, fixed vocabularies and variable vocabularies.

For the purposes of this disclosure, the term “schema” connotes a system of organization and structure of objects, which are comprised of entities and their associated characteristics. A schema may be said to describe a database, as in a conceptual schema, and may be translated into an explicit mapping within the context of a database management system. A schema may also be said to describe a system of entities and their relationships to one another; such as a collection of tags used to describe content or a hierarchy of types of artifacts. A schema may also include structure or collections regarding metadata, or information about artifacts (e.g., schema.org or the Dublin Core Metadata Initiative).

For the purposes of this disclosure, the term “ontology” connotes a system of organization and structure for all artifacts that may be addressed by an IR system, including how such entities may be grouped, related in a hierarchy and subdivided or differentiated based on similarities or differences. Ontologies comprise, in part, categories or classes or types, which may be subdivided into sub-categories or sub-classes or sub-types, which may be further divided into further sub-categories or sub-classes or sub-types, etc. For example, one ontology could include the classes “trees” and “rocks;” the class “trees” could include the subclasses “deciduous” and “evergreen;” the sub-class “deciduous” could include the sub-classes “oaks” and “elms;” and so on. Given ontologies may be described as fixed, to rely on a fixed vocabulary and to have a known, finite number of classes. Given ontologies may also be described as variable, to rely on a variable vocabulary and to have an unknown, theoretically infinite number of classes. Ontologies are often hierarchical structures that can be used in concert with one another in order to provide a clear definition of a concept, object or subject. For example, the scientist Albert Einstein could be simultaneously defined in one ontology as “homo sapiens” while being defined in others as “physicist,” “German,” “former Princeton faculty,” and “male” in others. Similarly, the same subject, concept or object could be associated with multiple classes in the same ontology. Leonardo da Vinci could be simultaneously associated within a single ontology with “sculptor,” “architect,” “painter,” “engineer,” “musician,” “botanist” and “inventor” (as well several others).

The term “taxonomy” is closely related to ontology. For the purposes of this disclosure, the distinction between taxonomy and ontology is that within the context of a single taxonomy, an object, subject or concept can be classified only once, as opposed to ontology, where an object may be associated with multiple types, classes or categories.

For the purpose of this disclosure, the term “vocabulary” connotes a collection of descriptive information labels that are associated with underlying categories, types or classes; the referent article to a given search dimension or search dimension value. Vocabularies are usually, but not always comprised of words or terms. For example, “red,” “mineral” and “dead English poets” could each be an example of items in a vocabulary. Alternative vocabularies can include or be comprised of other objects or forms of data. For example, an embodiment of the current invention could utilize a vocabulary that included the entity “FF0000,” the hexadecimal value for pure red color in an HTML document.

For the purpose of this disclosure, the term “fixed vocabulary” connotes a vocabulary that that is generally established and remains unchanged over time. While some editing or updating of a fixed vocabulary may take place over the lifetime of an IR system, the concept of these vocabularies is that they remain constant over time. Fixed vocabularies are usually, but not always, also controlled vocabularies.

Inversely, the term “variable vocabulary” connotes a volatile or dynamic vocabulary; one that changes over time, or grows dynamically as more items are added to it. Such vocabularies will likely vary substantially when sampled at one time or another during the life of an IR system. Variable vocabularies are usually, but not always, uncontrolled vocabularies.

For the purpose of this disclosure, the term “controlled vocabulary” connotes a vocabulary that is created and maintained by administrative users of an IR system, as opposed to the search users of the IR system.

For the purpose of this disclosure, the term “uncontrolled vocabulary” connotes a vocabulary that is created and maintained by the search users of the IR system, or the evidence that is acquired by the IR system about the artifacts it retrieves and analyzes.

For the purpose of this disclosure, the term “dictionary” connotes a vocabulary that couples labels with definitions (i.e., signs with denotata). Each label may be associated with one or more definitions, and it is possible that one or more labels may be associated with the same or indistinguishable definitions (e.g., polysemic or homonymic labels).

It should be noted that dictionaries and vocabularies are typically conceived in a manner that is without hierarchy. In other words, though the definition of the label (or sign) “anatomy” may have a relationship to the definition of “biology,” the organization of the structure of the vocabulary or dictionary does not recognize this hierarchical relationship.

For the purposes of this disclosure, the term “variable exclusivity” connotes an organizational system in which categories may either be mutually exclusive or inclusion permissive. Mutually exclusive categories are two or more categories with which a given artifact may be associated with only one, but not another. For example, an Internet page might be categorized as “child pornography” or “children's literature,” but it cannot be both. Inclusion permissive categories are two or more categories with which a given artifact may be associated with two or more. For example a given artifact might be categorized as “subject.medicine.pharmaceutical” and “segment.retail” without conflict. The preferred embodiment is to allow the default state of all categories to be inclusion permissive unless specifically configured otherwise, but it is also possible to make the default state of a category mutually exclusive.

For the purposes of this disclosure, within the context of describing categorical structure the term “flat” connotes un-hierarchical structures; generally having little or no ‘levels’ or hierarchy of classification (i.e., a structure which contains no substructure or subdivisions).

For the purposes of this disclosure, within the context of describing categorical structure the term “hierarchical” connotes structures that are modeled as a hierarchy; an arrangement of concepts, classes or types in which items may be arranged to be “above” or “below” one another, or “within” or “without” one another. In this context, one may speak of “parent” or “child” items, and/or of nested or branching relationships.

For the purposes of this disclosure, within the context of describing categorical structure, the terms “loose” or “unorganized” connote an organization, ontology, vocabulary, schema or taxonomy that has little or no hierarchy and is likely to contain multiple unassociated synonymous items.

For the purposes of this disclosure, within the context of describing categorical structure, the term “organized” connotes an organization, ontology, vocabulary, schema or taxonomy that has clearly defined hierarchy, tends not to contain synonymous items and/or, to the extent that it does contain multiple synonymous items, those items are associated with one another, so that potential ambiguities of association are avoided.

For the purposes of this disclosure, the term “folksonomy” connotes a system of classification that is derived either from the practice and method of collaboratively creating and managing a collection of categorical labels, frequently referred to as “tags,” for the purposes of annotating and categorizing artifacts, and/or is derived from a set of categorical terms utilized by members of a specific defined group.

Folk sonomies are generally unstructured and flat, but variants can exist that are hierarchical and organized. Folksonomies tend to be comprised of variable vocabularies, though instances of fixed vocabularies being utilized with folksonomies also exist.

Examples of IR systems with low-dimensional articulation include the search portals Google™ or Bing™. When using one of these systems, the user by default is exposed to a general “Search” vertical category. The user may select one of several other verticals such as “News” or “Images.” While initially entering terms the user may interact with the text entry box hints to disambiguate or in some cases, make limited dimensional distinctions, but in general lacks control, exposure and/or interactions that enable the user to understand, modify, manipulate or fully express any dimensional information. After entering terms or selecting a vertical, the user, in some cases, may be provided with additional fixed articulation for some dimensions that are salient within the selected vertical. For example, within images, users are provided with additional dimensional or facet inputs on the left part of the screen that enable dimensional interactions with “time,” “size,” “color” etc. The articulation of these dimensional inputs is entirely fixed. While a large number of dimensions are exposed within the overall UI of the search portal, only one categorical dimension (which in this case is synonymous with “vertical”) can be selected at a time.

Customarily, relevance is used solely as a measure of quality for results generated by an IR system. However, in context with systems that provide high degrees of dimensional articulation, relevance is also a measure of the quality of a number of system characteristics other than results generation, including facet casting, information conveyance and specificity. More relevant facet casting results in a higher correlation between a query and a user's information need. Apparatuses and processes that generate facet casting, facet inference, facet exposure and facet hinting may rely on relevancy processes and algorithms similar to those used to generate results (i.e. select and rank artifacts) in an IR system. Increased relevance that produces more intuitive, easy to understand, and contextually accurate responses within UI features related to dimensional articulation increase the quality of information conveyance to the user, which has a cascading effect on the quality of queries (specificity) entered by the user, concurrently and in future interactions. These processes and effects form a feedback loop which raises awareness and understanding on the part of the user about how the IR system operates while also raising the quality of results generated by the IR system, including precision, user relevance, topical relevance, boundary relevance, single and multi-dimensional relevance, higher correlation between information need and results related to recency and higher correlation between information need and results in general.

### Result Quality Measures

Relevance is often thought of as the primary measure of IR system result quality. Relevance is in practice a frequently intuitive measure by which result artifacts are said to correspond to the query input by a user of the IR system. While there are a number of abstract mathematical measures of relevance that can be said to precisely evaluate relevance in a specific and narrow way; their utility is demonstrably limited when considered alongside the opaque (at time of use) and complex decision making, assumptions and inferences made by a user when assembling a query. A good working definition of “relevance” is a measure of the degree to which a given artifact contains the information the user is searching for. It should also be noted that in some embodiments relevance can also be used to describe aspects of inference or disambiguation cues provided to the user to better articulate the facet casting or term hinting provided to the user in response to direct inputs.

Two common measures of evaluating the quality of relevance are “precision” and “recall.” Precision is the proportion of retrieved documents that are relevant (P=Re/Rt where P is precision, Re is the total number of retrieved relevant artifacts and Rt is the total number of all retrieved artifacts). Recall is the proportion of relevant documents that are retrieved of all possible relevant documents (R=Re/Ra where R is recall, Re is the total number of retrieved relevant artifacts and Rt is the total number of all possible relevant artifacts). Precision and recall can be applied as quality measures across a number of relevance characteristics.

The degree to which a retrieved artifact matches the intent of the user is often called “user relevance.” User relevance models most often rely on surveying users on how well results correspond to expectations. Sometimes it is extrapolated based on click-through or other metrics of observed user behavior.

Another set of relevance measures can be built around “topical relevance.” This is the degree to which a result artifact contains concepts that are within the same topical categories of the query. While topical can sometimes correspond with user intent, a result can be highly topically relevant and not represent the intent of the user at all. Alternatively, if a multi-faceted IR system is employed, this could be expressed as the proportion of defined topical categories for which an artifact is relevant to the total number of topical categories that were defined.

Another set of relevance measures can be built around “boundary relevance.” This is the degree to which a result artifact is sourced from within a defined boundary set characteristic. Alternatively, this could be expressed as the number of discrete organizational boundaries that must be crossed (or “hops”) from within a defined boundary set characteristic to find a given artifact (e.g., degrees of separation measured in a social network). Alternatively, this could be expressed as the subset of multiple boundary sets met by a given artifact.

If an IR system utilizes faceted term queries (that is, evaluates relevance against isolated meta-data stored about an artifact rather than the entire content of an artifact), then it can also utilize quality metrics that measure “single dimensional relevance.” That is, the degree to which result artifact corresponds to the query within the context of a given dimension. For example, if a search utilizes a geo-dimension and a user inputs a particular zip code, a given result can be measured by the absolute distance between its geo-location to that of the query. A collection of single dimensional relevance scores can be collected, weighted and aggregated to measure “multi-dimensional relevance.”

Other forms of quality measurement for IR systems focus on how rapidly new content can be added to the system, or, in cases where relevant, how quickly old content falls off or phases out of the system. “Coverage” measures how much of the extant accessible content that exists within the aggregate boundary set(s) of the system has been retrieved, analyzed, and made available for retrieval by the system. “Freshness” sometimes “Recency”) measures the “age” of the information available for retrieval in the system.

Another form of quality measurement is the degree to which spam has penetrated the system. “Spam” refers to artifacts that contain information that distorts the evidence produced by the IR system. This is often described as misleading, inappropriate or non-relevant content in results. This is typically intentional and done for commercial gain, but can also occur accidentally, and can occur in many forms and for many reasons. “Spam Penetration” measures the proportion of spam artifacts to all returned artifacts.

Still other qualitative and subjective methods exist to measure the performance of an IR system. These include, but are not limited to: efficiency, scalability, user experience, page visit duration, search refinement iterations and others.

### Curation

“Curation” is a discriminatory activity that selects, preserves, maintains, collects and stores artifacts. This activity can be embodied in a variety of systems, processes, methods and apparatuses. Stored artifacts may be grouped into ontologies or other categorical sets. Even if only implicit, all IR systems use some form of curation. At the simplest level this could be the discriminatory characteristic of an IR system that determines it will only retrieve HTML artifacts while all other forms of artifact are ignored. More complex forms of curation rely on machine intelligence processes to categorize or rank artifacts or sub-elements of artifacts against definitions, rules or measures of what determines if an artifact belongs to a particular category or class. This could, for example, determine what artifacts are considered “news” and what artifacts are not. In some embodiments, the process of curation is referred to as “tagging.”

In some embodiments, curation depends on automated machine processes. Methods such as clustering, Bayesian Analysis and SVM are utilized as parts of systems that include these processes. For purposes of this disclosure, the term “machine curation” will be used to identify such processes.

In some embodiments, curation is performed by human beings, who may interact with an IR system to indicate whether a given artifact belongs to a particular category or class. For purposes of this disclosure, the term “human curation” will be used to identify such processes.

In some embodiments, curation may be performed in an intermingled or cooperative fashion by machine processes and human beings interacting with machine processes. For purposes of this disclosure, the term “hybrid curation” will be used to identify such processes.

“Sheer curation” is a term that describes curation that is integrated into an existing workflow of creating or managing artifacts or other assets. Sheer curation relies on the close integration of effortless, low effort, invisible, automated, workflow-blocking or transparent steps in the creation, sharing, publication, distribution or management of artifacts. The ideal of sheer curation is to identify, promote and utilize tools and best practices that enable, augment and enrich curatorial stewardship and preservation of curatorial information to enhance the use of, access to and sustainability of artifacts over long and short term periods.

“Channelization” or “channelized curation” refers to continuous curation of artifacts as they are published, thereby rendering steady flows of content for various forms of consumption. Such flows of content are often referred to as “channels.”

### Natural Language Processing

The term “natural language processing” or “NLP” connotes a field of computer science, artificial intelligence, and linguistics concerned with the interactions between computers and human (natural) languages. As such, NLP is related to the area of human-computer interaction.

The term “natural language understanding” is a subtopic of natural language processing in artificial intelligence that deals with machine reading comprehension. This may comprise conversion of sections of text into more formal representations such as first-order logic structures that are easier for computer programs to manipulate. Natural language understanding involves the identification of the intended semantic from the multiple possible semantics which can be derived from a natural language expression which usually takes the form of organized notations of natural languages concepts.

The term “machine reading comprehension” or “human reading comprehension” connotes the level of understanding of a text/message or language communication. This understanding comes from the interaction between the words that are written and how they trigger knowledge outside the text/message.

The term “automatic summarization” connotes the production of a readable summary of a body of text. This is often used to provide summaries of text of a known type, such as articles in the financial section of a newspaper.

The term “coreference resolution” connotes a process that given a sentence or larger chunk of text, determines which words (“mention”) refer to the same objects (“entities”).

The term “anaphora resolution” connotes an example of a coreference solution that is specifically concerned with matching up pronouns with the nouns or names that they refer to.

The term “discourse analysis” connotes a number of methods related to: identifying the discourse structure of subsections of text (e.g., elaboration, explanation, contrast); or recognizing and classifying the speech acts in a subsection of text (e.g., yes-no question, content question, statement, assertion, etc.).

The term “machine translation” connotes the automated translation of text in one language into text with the same meaning in another language.

The term “morphological segmentation” connotes the sorting of words into individual morphemes and identification of the class of the morphemes. The difficulty of this task depends greatly on the complexity of the morphology (i.e., the structure of words) of the language being considered. English has fairly simple morphology, especially inflectional morphology, and thus it is often possible to ignore this task entirely and simply model all possible forms of a word (e.g., “open, opens, opened, opening”) as separate words. In languages such as Turkish, however, such an approach is not possible, as each dictionary entry has thousands of possible word forms.

The term “named entity recognition” or “NER” connotes the determination of which items in given text map to proper names, such as people or places, and what the type of each such name is (e.g., person, location, organization).

The term “natural language generation” connotes the generation of readable human language based on stored machine values from a machine readable medium.

The term “part-of-speech tagging” connotes the identification of the part of speech for a given word. Many words, especially common ones, can serve as multiple parts of speech. For example, “book” can be a noun (“the book on the table”) or verb (“to book a flight”); “set” can be a noun, verb or adjective; and “out” can be any of at least five different parts of speech. Note that some languages have more such ambiguity than others. Languages with little inflectional morphology, such as English are particularly prone to such ambiguity. Chinese is prone to such ambiguity because it is a tonal language during verbalization. Such inflection is not readily conveyed via the entities employed within the orthography to convey intended meaning.

The term “parsing” in the context of NLP or NLP related text analysis may connote the determination of the parse tree (grammatical analysis) of a given sentence. The grammar for natural languages is ambiguous and typical sentences have multiple possible analyses. In fact, perhaps surprisingly, for a typical sentence there may be thousands of potential parses (most of which will seem completely nonsensical to a human).

The term “question answering” connotes a method of generating an answer based on a human language question. Typical questions have a specific right answer (such as “What is the capital of Canada?”), but sometimes open-ended questions are also considered (such as “What is the meaning of life?”).

The term “relationship extraction” connotes a method for identifying the relationships among named entities in a given section of text (e.g., Wwho is the son of whom?)

The term “sentence breaking” or “sentence boundary disambiguation” connotes a method for identifying the boundaries of sentences. Sentence boundaries are often marked by periods or other punctuation marks, but these same characters can serve other purposes (e.g., marking abbreviations).

The term “sentiment analysis” connotes a method for the extraction of subjective information usually from a set of documents, often using online reviews to determine “polarity” about specific objects. It is especially useful for identifying trends of public opinion in the social media, for the purpose of marketing.

The term “speech recognition” connotes a method for the conversion of a given sound recording into a textual representation.

The term “speech segmentation” connotes a method for separating the sounds of a given a sound recording into its constituent words.

The term “topic segmentation” and/or “topic recognition” connotes a method for identifying the topic of a section of text.

The term “word segmentation” connotes the separation of continuous text into constituent words. Word segmentation: Separate a chunk of continuous text into separate words. For a language like English, this is fairly trivial, since words are usually separated by spaces. However, some written languages like Chinese, Japanese and Thai do not mark word boundaries in such a fashion, and in those languages text segmentation is a significant task requiring knowledge of the vocabulary and morphology of words in the language.

The term “word sense disambiguation” connotes the selection of a meaning for the use of a given word in a given textual context. Many words have more than one meaning; we have to select the meaning which makes the most sense in context.

### Human Machine Interaction

The term “Human-Machine Interaction” or “human-computer interaction,” “HMI” or “HCl”) connotes the study, planning, and design of the interaction between people (users) and computers. It is often regarded as the intersection of computer science, behavioral sciences, design and several other fields of study. In complex systems, the human-machine interface is typically computerized. The term connotes that, unlike other tools with only limited uses (such as a hammer, useful for driving nails, but not much else), a computer has many affordances for use and this takes place in an open-ended dialog between the user and the computer.

The term “Affordance” connotes a quality of an object, or an environment, which allows an individual to perform an action. For example, a knob affords twisting, and perhaps pushing, while a cord affords pulling. The term is used in a variety of fields: perceptual psychology, cognitive psychology, environmental psychology, industrial design, human-computer interaction (HCl), interaction design, instructional design and artificial intelligence.

The term “Information Design” is the practice of presenting information in a way that fosters efficient and effective understanding of it. The term has come to be used specifically for graphic design for displaying information effectively, rather than just attractively or for artistic expression.

The term “Communication” connotes information communicated between a human and a machine; specifically a human-machine interaction that occurs within the context of a user interface rendered and interacted with on a computing device. This term can also connote communication between modules or other machine components.

The term “User Interface” (UI) connotes the space where interaction between humans and machines occurs. The goal of this interaction is effective operation and control of the machine on the user's end, and feedback from the machine, which aids the operator in making operational decisions. A UI may include, but is not limited to, a display device for interaction with a user via a pointing device, mouse, touchscreen, keyboard, a detected physical hand and/or arm or eye gesture, or other input device. A UI may further be embodied as a set of display objects contained within a presentation space. These objects provide presentations of the state of the software and expose opportunities for interaction from the user.

The term “User Experience” (“UX” or “UE”) connotes a person's emotions, opinions and experience in relation to using a particular product, system or service. User experience highlights the experiential, affective, meaningful and valuable aspects of human-computer interaction and product ownership. Additionally, it includes a person's perceptions of the practical aspects such as utility, ease of use and efficiency of the system. User experience is subjective in nature because it is about individual perception and thought with respect to the system.

“Cognitive Load” connotes the capacity of a human being to perceive and act within the context of human-machine interaction. This is a term use in cognitive psychology to illustrate the load related to the executive control of working memory (WM). Theories contend that during complex learning activities the amount of information and interactions that must be processed simultaneously can either under-load, or overload the finite amount of working memory one possesses. All elements must be processed before meaningful learning can continue. In the field of HCl, cognitive load can be used to refer to the load related to the perception and understanding of a given user interface on a total, screen, or sub-screen context. A complex, difficult UI can be said to have a high cognitive load, while a simple, easy to understand UI can be said to have a low cognitive load.

The term “Form” (in some cases “web form” or “HTML form”) generally connotes a screen, embodied in HTML or other language or format that allows a user to enter data that is consumed by software. Typically, forms resemble paper forms because they include elements such as text boxes, radio buttons or checkboxes.

### Code

“Code” in the context of encoding, or coding system, connotes a rule for converting a piece of information (for example, a letter, word, phrase, gesture) into another form or representation (one sign into another sign), not necessarily of the same type. Coding enables or augments communication in places where ordinary spoken or written language is difficult, impossible or undesirable. In other contexts, code connotes portions of software instruction.

“Encoding” connotes the process by which information from a source is converted into symbols to be communicated (i.e., the coded sign).

“Decoding” connotes the reverse process, converting these code symbols back into information understandable by a receiver (i.e., the information).

“Coding System” connotes a system of classification utilizing a specified set of sensory cues (such as, but not limited to color, sound, character glyph style, position or scale) in isolation or in concert with other information representations in order to communicate attributes or meta information about a given term object.

“Auxiliary Code Utilization” connotes the utilization of a coding system in a subordinate role to another, primary method of communicating a give attribute.

“Code Set” in the context of encoding or code systems, connotes the collection of signs into which information is encoded.

“Color Code” connotes a coding system for displaying or communicating information by using different colors.

### Other Information

For the purposes of this disclosure, the term “server” should be understood to refer to a service point which provides processing and/or database and/or communication facilities. By way of example, and not limitation, the term “server” can refer to a single, physical processor with associated communications and/or data storage and/or database facilities, or it can refer to a networked or clustered complex of processors and/or associated network and storage devices, as well as operating software and/or one or more database systems and/or applications software which support the services provided by the server.

For the purposes of this disclosure, the term “end user” or “user” should be understood to refer to a consumer of data supplied by a data provider. By way of example, and not limitation, the term “end user” can refer to a person who receives data provided by the data provider over the Internet in a browser session, or can refer to an automated software application which receives the data and stores or processes the data.

For the purposes of this disclosure, the term “database”, “DB” or “data store” should be understood to refer to an organized collection of data on a computer readable medium. This includes, but is not limited to the data, its supporting data structures; logical databases, physical databases, arrays of databases, relational databases, flat files, document-oriented database systems, content in the database or other sub-components of the database, but does not, unless otherwise specified, refer to any specific implementation of data structure, database management system (DBMS).

For the purposes of this disclosure, a “computer readable medium” stores computer data in machine readable format. By way of example, and not limitation, a computer readable medium can comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid-state memory technology, CD-ROM, DVD, or other optical storage, magnetic cassettes, magnetic tape, magnetic disk storage or other mass storage devices, or any other medium which can be used to store the desired information and which can be accessed by the computer. The term “storage” may also be used to indicate a computer readable medium. The term “stored” in some contexts where there is a possible implication that a record, record set or other form of information existed prior to the storage event, should be interpreted to include the act of updating the existing record, dependent on the needs of a given embodiment. Distinctions on the variable meaning of storing “on,” “in,” “within,” “via” or other prepositions are meaningless distinctions in the context of this term.

For the purposes of this disclosure a “module” is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium. Modules may be integral to one or more servers, or be loaded and executed by one or more servers. One or more modules may grouped into an engine or an application.

For the purposes of this disclosure, a “social network” connotes a social networking service, platform or site that focuses on or includes features that focus on facilitating the building of social networks or social relations among people and/or entities (participants) who share some commonality, including but not limited to interests, background, activities, professional affiliation, virtual connections or affiliations or virtual connections or affiliations. In this context the term entity should be understood to indicate an organization, company, brand or other non-person entity that may have a representation on a social network. A social network consists of representations of each participant and a variety of services that are more or less intertwined with the social connections between and among participants. Many social networks are web-based and enable interaction among participants over the Internet, including but not limited to e-mail, instant messaging, threads, pinboards, sharing and message boards. Social networking sites allow users to share ideas, activities, events, and interests within their individual networks. Examples of social networks include Facebook™, MySpace™, Google+™, Yammer™, Yelp™, Badoo™, Orkut™, LinkedIn™ and deviantArt™ Social sharing networks may sometimes be excluded from the definition of a social network due to the fact that in some cases they do not provide all the customary features of a social network or rely on another social network to provide those features. For the purposes of this disclosure such social sharing networks are explicitly included in and should be considered synonymous with social networks. Social sharing applications including social news, social bookmarking, social/collaborative curation, social photo sharing, social media sharing, discovery engines with social network features, microblogging with social network features, mind-mapping engines with social network features and curation engines with social network features are all included in the term social network within this disclosure. Examples of these kinds of services include Reddit™, Twitter′, StumbleUpon™, Delicious™, Pearltrees′M and Flickr™.

In some contexts, the term “social network” may also be interpreted to mean one entity within the network and all entities connected by a specific number of degrees of separation. For example, entity A is “friends” with (i.e., has a one node or one degree association with) entities B, C and D. Entity D is “friends” with entity E. Entity E is “friends” with entity F. Entity G is friends with entity Z. “A's social network” without additional qualification, synonymous with “A's social network” to one degree of separation, should be understood to mean a set including A, B, C and D, where E, F, G and Z are the negative or exclusion set. “A's social network” to two degrees of separation should be understood to be a set including A, B, C, D and E, where F, G and Z are the negative or exclusion set. “A's social network” to various, variable or possible degrees of separation or the like should be understood to be a reference to all possible descriptions of “A's social network” to n degrees of separation, where n is any positive integer; in this case, depending on n, including up to A through F, but never G and Z, except in a negative or exclusion set.

The term “social network feed” connotes the totality of content (artifacts and meta-information) that appears within a given social network platform that is associated with a given entity. If associative reference is also given to artifacts via degrees of separation, that content is also included.

“Attributes” connotes specific data representations, (e.g., tuples <attribute name, value, rank>) associated with a specific term object.

Name-Value Pair” connotes a specific type of attribute construction consisting of an ordered pair tuple (e.g., <attribute name, value>).

“Term Object” connotes collections of information used as part of an information retrieval system that include a term, and various attributes, which may include attributes that are part of a coding system related to this invention or may belong to other possible attribute sets that are unrelated to part of a coding system.

The term “sign” or “signifier” connotes information encoded in a form to have one or more distinct meanings, or denotata. In the context of this disclosure the term “sign” should be interpreted and contemplated both in terms of its meaning in linguistics and semiotics. In linguistics a sign is information (usually a word or symbol) that is associated with or encompasses one or more specific definitions. In semiotics a sign is information, or any sensory input expressed in any medium (a word, a symbol, a color, a sound, a picture, a smell, the state or style of information, etc.)

The term “denotata” connotes the underlying meaning on a sign, independent of any of the sensory aspects of the sign. Thus the word:“chair” and picture of a chair could both be said to be signs of the denotata of the concept of “chair,” which can be said to exist independently of the word or the picture.

The term “sememe” connotes an atomic or indivisible unit of transmitted or intended meaning. A sememe can be the meaning expressed by a morpheme, such as the English pluralizing morpheme −s, which carries the sememic feature [+plural]. Alternatively, a single sememe (for example [go] or [move]) can be conceived as the abstract representation of such verbs as skate, roll, jump, slide, turn, or boogie. It can be thought of as the semantic counterpart to any of the following: a meme in a culture, a gene in a genetic make-up, or an atom (or, more specifically, an elementary particle) in a substance. A seme is the name for the smallest unit of meaning recognized in semantics, referring to a single characteristic of a sememe. For many purposes of the current disclosure the term sememe and denotata are equivalent.

The term of “sememetically linked” connotes a condition or state where a given term is associated with a single primary sememe. It may also refer to a state where one or more additional alternative secondary (or alternative) sememe have been associated with the same term. Each associated primary or secondary sememe association may be scored or ranked for applicability to the inferred user intent. Each associated primary or secondary sememe association may also be additionally scored or ranked by manual selection from the user.

The term “sememetic pivot” describes a set of steps wherein a user tacitly or manually selects one sememetic association as opposed to another and the specific down-process effects such a decision has on the resulting artifact selection or putative artifact selection an IR system may produce in response to selecting one association as opposed to the other.

The term “state” or “style” in context of information connotes a particular method in which any form encoding information may be altered for sensory observation beyond the specific glyphs of any letters, symbols or other sensory elements involved. The most readily familiar examples would be in the treatment of text. For example, the word “red” can be said to have a particular style in that it is shown in a given color, on a background of a given color, in a particular font, with a particular font weight (i.e., character thickness), without being italicized, underlined, or otherwise emphasized or distinguished and as such would comprise a particular sign with one or more particular denotata. Whereas the same word “red” could be presented with yellow letters (glyphs) on a black background, italicized and bolded, and thus potentially could be described as a distinct sign with alternate additional or possible multiple denotata.

The term “cognit” connotes a node in a cognium consisting of a series of attributes, such as label, definition, cognospect and other attributes as dynamically assigned during its existence in a cognium. The label may be one or more terms representing a concept. This also encompasses a super set of the semiotic pair sign/signifier—denotata as well as the concept of a sememe. (cognits—pl.).

The term “cognium,” “manifold variable ontology” or “MVO” connotes an organizational structure and informational storage schema that integrates many features of an ontology, vocabulary, dictionary, and a mapping system. In at least one embodiment, a cognium is hierarchically structured like an ontology, though alternate embodiments may be flat or non-hierarchically networked. This structure may also consist of several root categories that exist within or contain independent hierarchies. Each node or record of a cognium is variably exclusive. In some embodiments, each node is associated with one or more labels and the meaning of the denotata of each category is also contained or referenced. A cognium is comprised of collection of cognits that is variably exclusive and manifold; can be categorical, hierarchical, referential and networked. It can loosely be thought of as a super set of an ontology, taxonomy, dictionary, vocabulary and n-dimensional coordinate system. (cogniums—pl.).

Within a cognium, the cognits inherit the following integrity restrictions.

1. Each cognit is identifiable by its attribute set, such as collectively the label, definition, cognospect, etc. The combination of attributes is required to be unique.

2. Each cognit must designate one and only one attribute as a unique identifier, this is considered a mandatory attribute and all other attributes are considered not mandatory.

3. Cognit attributes may exist one or more times provided the attribute and value pair is unique, for example the attribute “label” may exist once with the value “A” and again with the value “B.”

4. A cognit which does not have an attribute is not interpreted the same as a cognit which has an attribute with a null or empty value, for example cognit “A” does not have the “weight” attribute and cognit “B” has a “weight” attribute that is null, cognit “A” is said to not contain the attribute “weight” and cognit “B” is said to contain the attribute.

5. The definition of a cognit must be unique within its cognospect.

6. Relationships and associations designated hierarchical between cognits cannot create an infinite referential loop at any lineage or branch within the hierarchy, for example cognit “A” has a parent “B” and therefore cognit “B” cannot have a parent

“A.”

7. Relationships and associations not designated hierarchical between cognits can be infinitely referential, for example cognit “A” has a sibling “B′” and cognit “B” has a sibling “A′.”

8. Only one relationship or association defined in a mutually exclusive group may appear between the same cognits, for example cognit “A” is a synonym of cognit “B” and therefore cognit “B” cannot be an antonym of cognit “A.”

9. Any relationship and association between cognits must be unique (i.e., not repeated and not redundant). For example, cognit “A” is contained in cognit “B” may only exist once.

10. Relationships and associations defined in a mutually inclusive group will exist as a single relationship between cognits, for example if “brother,” “sister,” and “sibling” are defined mutually inclusive, only one is designated for use.

11. Relationships and associations defined as hierarchical automatically define a mutually inclusive group to parent ancestry and all descendants. For example, cognit “A” is a parent of cognit “B” and cognit “X” is a sibling of cognit “A” therefor cognit “X” also inherits all associations to the parent lineage of cognit “A” and all children and descendants of cognit “A.”

12. Relationships and associations defined in a rule set will be applied equally to all associated cognits. For example, a rule which states all cognits associated with cognit “A” require a label attribute will cause the cognium to reject the addition of the relationship to cognit “B” until and unless a label attribute is defined on cognit “B.”

The term “cognology” connotes the act or science of constructing a cognium (cognological—adj, cognologies—pl.).

The term “cognospect” connotes the context of an individual cognit within a cognium. The context of a cognit may be identified by one or more attributes assigned to the cognit and when taken collectively with its label and definition, uniquely identify the cognit.

The usage of any terms defined within this disclosure should always be contemplated to connote all possible meanings provided, in addition to their common usages, to the fullest extent possible, inclusively, rather than exclusively.

### Interpretation Considerations

When reading this section (which describes an exemplary embodiment of the best mode of the invention, hereinafter “exemplary embodiment”), one should keep in mind several points.

First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way. Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential.

Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”).

Fourth, unless explicitly stated otherwise, conjunctive words (such as “or”, “and”, “including”, or “comprising” for example) should be interpreted in the inclusive, not the exclusive, sense.

Fifth, the words “means” and “step” are provided to facilitate the reader's understanding of the invention and do not mean “means” or “step” as defined in §112, paragraph 6 of 35 U.S.C., unless used as “means for—functioning—” or “step for—functioning—” in the Claims section.

Sixth, the invention is also described in view of the Festo decisions, and, in that regard, the claims and the invention incorporate equivalents known, unknown, foreseeable, and unforeseeable.

Seventh, the language and each word used in the invention should be given the ordinary interpretation of the language and the word, unless indicated otherwise.

Some methods of various embodiments may be practiced by placing the invention on a computer-readable medium, particularly control and detection/feedback methodologies. Computer-readable mediums include passive data storage, such as a random access memory (RAM) as well as semi-permanent data storage. In addition, the invention may be embodied in the RAM of a computer and effectively transform a standard computer into a new specific computing machine.

Data elements are organizations of data. One data element could be a simple electric signal placed on a data cable. One common and more sophisticated data element is called a packet. Other data elements could include packets with additional headers/footers/flags. Data signals comprise data, and are carried across transmission mediums and store and transport various data structures, and, thus, may be used to operate the methods of the invention. It should be noted in the following discussion that acts with like names are performed in like manners, unless otherwise stated. Of course, the foregoing discussions and, definitions are provided for clarification purposes and are not limiting. Words and phrases are to be given their ordinary plain meaning unless indicated otherwise.

The numerous innovative teachings of present application are described with particular reference to presently preferred embodiments.

### I. Complex Form Streamlining Method and Apparatus for Human Machine Interaction

Various embodiments are described below with reference to block diagrams and operational illustrations of methods and devices related to the current invention. It should be understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer, special purpose computer, ASIC, or other programmable data processing apparatus, such that the instructions, which execute via the processor of the computer or other programmable data processing apparatus, implements the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

FIG. 1 Illustrates the process by which dynamic input objects are used from the context of a form, which is presented via an application UI, the presentation of which, in an ideal embodiment, is managed by a controller or other software module. The process begins [101] when the form i rendered to the UI. When a user interacts with a dynamic input object by entering (or in some alternate embodiments, selecting) a value [102] the system responds by looking up the entered value in order to match a potential intent for the value [103]. The software process or module refers to a Value Reference Data Store [104] and locates one or more possible intents for the given value. In at least some embodiments, if more than one potential intent is retrieved, the selection of potential intents are ranked or scored for greatest likelihood. The returned potential intent, or the highest ranking returned potential intent is then “cast” in the UI; the role of the input group that was inferred via the Value Reference Data is presented and set as the designated role of the input group in the UI [105], in many embodiments this is in the form of changing the label (and any related feedback elements) within the input object, but this may also include other presentations such as color, text style, icons, or other sensory presentations to communicate the interpreted or inferred intent of the input object given a particular value. At this point, the user may add a second, third or additional value, or may modify an existing value [106]. If the user adds a new value or modifies an existing value [161] then the process returns to [102]. Otherwise, the process proceeds to [162], which may include additional interactions with other form objects, but eventually results in form submission [107] and ends the process [108] by returning or transferring control to the initializing controller, or other software module.

FIG. 2 illustrates the dynamic intent generation process from the context of the dynamic input object. Reference to software modules, controllers, and/or other contextual information has been intentionally omitted from this description in order to maintain clarity. One skilled in the art will be able to understand the various forms of context within which this process is applicable, including but not limited to HTML forms, dynamic HTML forms, and other software screen forms. The process begins when the UI is presented and ready to receive input from the user [201]. At this point in the process the input object presents its default state [202], which depending on the particular implementation and the particular configuration of the object, may be described as “stateless” (i.e., be without assigned intent) or have a particular assigned default intent. The remainder of the process is dependent on whether or not the default value (which may simply be null) is changed [203]. When the value is changed via direct or indirect input from the user [231] the system proceeds to request an intent for the given value [204] from a software module that performs a lookup or match search—returning one or more valid potential intents for the given value [205]. The system recognizes the returned potential intent (or the highest ranked of a set of potential intents) to change the state of the UI object so that its logical state or self-identified state represents the same intent [206]. This internal state may eventually find expression in any specific operational rules, business rules or other variable behaviors within other modules of the software or receiving software. In other words, the value of the input object will be communicated to any receiving modules or processes cast in the context of the inferred intent. The system utilizes the returned potential intent (or the highest ranked of a set of potential intents) to change the state of the UI object so that it represents the inferred intent to the user [207]. Note that in preferred embodiments the UI enables the user to manually select from all possible intents or all potential intents. While steps [231] through [207] are occurring the UI object may present an altered state to the user in order to communicate a state of processing. When the inferred intent has been identified and displayed the system will return to a passive state [208] awaiting further input from the user. If there are no further value changes or inputs and/or no inputs at all [232], the current state (default or inferred) will be communicated to any downstream processes or modules and this process ends [209].

Forms are typically a collection of groups of “input object groups” (or simply “input object” or “input group”) comprised of: an input element (text box, check box, radio button, selection menu, etc.); coupled with a label element (usually a text label positioned over or alongside each input element, though in some variant cases it may be conditionally within the input element); sometimes coupled with a feedback (or validation) element; and if the input object includes a fixed or static list of possible inputs, then there will be a mechanism for listing labeling and enabling the selection of one or more elements in the list, with various rules for their selection—i.e., radio buttons, menus, pick lists, etc.). Note that the idea of an input object group is distinct from “input element” which is a reference to the specific mechanism used for capturing user input, without the accompanying elements.

Typical methods of form construction fall into two categories with varying degrees of dynamic modularity and adaptability. The most common method of form construction is to include all elements in the form statically. The second typical method is to display or hide various specific input objects or sets of input objects based on the current values that have been selected or input in the visible elements: such dynamic form methods are mechanisms that are designed to decrease the cognitive load of the user. These two general categories hold true across most every type of form implementation, even those that are embodied in multi-page or multiple time intervals. There are some forms that also generate new additional input objects based on prior input or captured data. From the perspective of this disclosure, the most common attribute that these extant methods share is that the role of each dynamic input object is fixed. For example, if someone enters an age over 60 years in an age field in a form, the form may respond by displaying a “Retired: yes [ ] no [ ]” radio input object that is otherwise displayed. But, the precise role played by the input object contemplated by the logic of the software behind the form is fixed: i.e., the user cannot interact with the “retired” object to change its meaning. Even in a case where the same form may also display a “In School: yes [ ] no [ ]” if the input age of the prior field was under 30 years, where the underlying software may display one or more additional fields, the specific potentially displayed fields have specifically assigned meanings and modes. For purposes of this disclosure this quality of the input object will be referred to as its “intent.”

One example embodiment of the invention includes a collection of methods and processes that enable a high degree of dynamic modularity and adaptability with minimal cognitive load, but rely on a different method than dynamic display or hiding of input objects or sets of input objects to generate dynamic form elements. Most examples are also differentiated from extant methods by the fact that the role of the data as it is consumed by downstream processes or software modules is fixed by the specific input object that captured it. One possible implementation eliminates the need to cast a specific datum in a specific role based solely on when or where it was entered, enabling much more flexible, simple and streamlined forms with correspondingly lower cognitive loads.

The methods and processes of most implementations are comprised of dynamic generation of input objects comprised of: a dynamic label, a dynamic input element; and a dynamic intent; and may also incorporate additional common features of input groups such as feedback mechanisms. At least one embodiment disclosed here was originally created to support search (specifically dimensional search) applications, but has applicability in a number of form applications.

It should be noted that prior to value entry by a user the input object may, depending on the precise implementation, be in a number of different states, including, but not limited to: stateless, defaulted to a specific intent (e.g., “term,” then refined to “text term” or “search category,” etc.), or defaulted to a generic/categorical intent (e.g., “name,” then refined to first, last etc. based on intent inference).

For the purposes of this disclosure, the term “intent inference” refers to a process of predicting the implicit intention of a user's interaction with a given input object via the input value provided. This inference is a prediction of the user's desire of how the input should be interpreted. (e.g., if the user were to enter “Kareem Abdul Jabbar” one embodiment may infer the intent of the input object to be “basketball player”). The response of the various components of a preferred embodiment system to the inference is to record all associated attributes of the intent (including, but not limited to label, disambiguation cues and validation cues) and display in the context of the input object within the UI. After intent inference occurs in the preferred embodiment, a given input object moves into a static state. The static state represents an opportunity (either passive, explicit or prompted) for the user to react to the presented interpretation of the value that was input. The user reaction may include, but is not limited to correction, acceptance, negation, etc. of the interpretation and may occur passively, explicitly or manually.

According to at least one example embodiment, a method includes the selection of a potential intent based on the input of a particular value; the application of a selected intent to a given input element's data attributes; the application of a selected intent to a given input element's presentation within a UI; and the application of a selected intent to the interpretation of a given element's value by a receiving or monitoring software process or module.

According to one potential aspect, one or more potential intents are selected. According to another potential aspect, one or more potential intents are ranked or scored. A given element's presentation may be expressed in an input object label. A given element's presentation may be expressed in color. A given element's presentation may be expressed in the style or font of text of an input object label. A given element's presentation may be expressed in sound. A given element's presentation may be expressed in surrounding or visually associated graphical elements or icons.

### II. Encoded Sensory System for Dimensional Related Human Machine Interaction

Various embodiments describe below are related to systems, apparatuses and methods for human-machine interaction, specifically forms, screens and other UI implementations that are designed to enable a user to provide or be queried for information. It specifically addresses the problem of the high cognitive load associated with large and complex forms (for example, an advanced search form), or for forms where there is a high ratio of possible inputs to required inputs. The invention extends other methods that utilize the data input into a generic, stateless, or semi-generic input object to infer the intent of the input value from the user. It then communicates that inference back to the user via an encoded sensory system, providing them with an opportunity to alter or correct the value of the inference. This invention enables forms to be simpler, shorter and more elegant (i.e. require a lower cognitive load) and provide affordances on an as-needed basis as opposed to an all-at-once basis.

One example is a set of systems, apparatuses, and methods that implement acts comprising: a process for enabling the utilization of the precise minimum of fields from a potentially much larger possible number of fields to capture a user's intended input; a process for adapting the intent of each enabled field to dynamically react to the specific input provided; a process for modifying the role of a given field within a form on the basis of the input provided; a process for altering the presentation of input objects on the basis of the provided input they contain; and then the communication of the inferred and/or assigned role of the input object via an encoded sensory system.

One example is a set of systems, apparatuses, and methods comprised of a set(s) of modules comprising one or more processors programmed to execute software code retrieved from a computer readable storage medium containing software processes. This system is embodied as a set(s) of process and UI modules including: modules for enabling the utilization of the precise minimum of fields from a potentially much larger possible number of fields to capture a user's intended input; modules for adapting the intent of each enabled field to dynamically react to the specific input provided; modules for modifying the role of a given field within a form on the basis of the input provided; modules for altering the presentation of input objects on the basis of the provided input they contain; and modules for the communication of the inferred and/or assigned role of the input object via an encoded sensory system.

One example is alternatively a system, method or apparatus comprised of a set of modules or objects comprising one or more processors programmed to execute software code retrieved from a computer readable storage medium containing software processes. This system is embodied as a set hidden process and UI modules and display objects contained within a presentation space, including: modules for enabling the utilization of the precise minimum of fields from a potentially much larger possible number of fields to capture a user's intended input; modules for adapting the intent of each enabled field to dynamically react to the specific input provided; modules for modifying the role of a given field within a form on the basis of the input provided; modules for altering the presentation of input objects on the basis of the provided input they contain; and modules for the communication of the inferred and/or assigned role of the input object via an encoded sensory system.

Various embodiments are described below with reference to block diagrams and operational illustrations of methods and devices related to the current invention. It should be understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer, special purpose computer, ASIC, or other programmable data processing apparatus, such that the instructions, which execute via the processor of the computer or other programmable data processing apparatus, implements the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

FIG. 1 Illustrates the process by which dynamic input objects are used from the context of a form, which is presented via an application UI, the presentation of which, in an ideal embodiment, is managed by a controller or other software module. The process begins [101] when the form rendered to the UI. When a user interacts with a dynamic input object by entering (or in some alternate embodiments, selecting) a value [102] the system responds by looking up the entered value in order to match a potential intent for the value [103]. The software process or module refers to a Value Reference Data Store [104] and locates one or more possible intents for the given value. In certain embodiments, if more than one potential intent is retrieved, the selection of potential intents are ranked or scored for greatest likelihood. The returned potential intent, or the highest ranking returned potential intent is then “cast” in the UI; the role of the input group that was inferred via the Value Reference Data is presented and set as the designated role of the input group in the UI [105], in many embodiments this is in the form of changing the label (and any related feedback elements) within the input object, but this may also include other presentations such as color, text style, icons, or other sensory presentations to communicate the interpreted or inferred intent of the input object given a particular value. At this point, the user may add a second, third or additional value, or may modify an existing value [106]. If the user adds a new value or modifies an existing value [161] then the process returns to [102]. Otherwise, the process proceeds to [162], which may include additional interactions with other form objects, but eventually results in form submission [3.7] and ends the process [108] by returning or transferring control to the initializing controller, or other software module.

FIG. 2 illustrates the dynamic intent generation process from the context of the dynamic input object. Reference to containing software modules, controllers and/or other contextual information has been intentionally omitted from this description in order to maintain clarity. One skilled in the art will be able to understand the various forms of context within which this process is applicable, including but not limited to HTML forms, dynamic HTML forms, and other software screen forms. The process begins when the UI is presented and ready to receive input from the user [201]. At this point in the process the input object presents its default state [202], which depending on the particular implementation the particular configuration of the object, may be described as “stateless” (i.e., be without assigned intent) or have a particular assigned default intent. The remainder of the process is dependent on whether or not the default value (which may simply be null) is changed [203]. When the value is changed via direct or indirect input from the user [231] the system proceeds to request an intent for the given value [204] from a software module that performs a lookup or match search—returning one or more valid potential intents for the given value [205]. The system recognizes the returned potential intent (or the highest ranked of a set of potential intents) to change the state of the UI object so that its logical state or self-identified state represents the same intent [206]. This internal state may eventually find expression in any specific operational rules, business rules or other variable behaviors within other modules of the software or receiving software. In other words, the value of the input object will be communicated to any receiving modules or processes cast in the context of the inferred intent. The system utilizes the returned potential intent (or the highest ranked of a set of potential intents) to change the state of the UI object so that it represents the inferred intent to the user [207]. Note that in preferred embodiments the UI enables the use to manually select from all possible intents or all potential intents. While steps [231] through [207] are occurring the UI object may present an altered state to the user in order to communicate a state of processing. When the inferred intent has been identified and displayed the system will return to a passive state [208] awaiting further input from the user. If there are no further value changes or inputs and/or no inputs at all [232], the current state (default or inferred) will be communicated to any downstream processes or modules and this process ends [209].

FIG. 3 illustrates the process by which the presentation of sensory coded information to a user is updated on the basis of a value change in the display object. In some embodiments this is a sub-process of that illustrated in “Display Intent” [307]. In the exemplary embodiment this process is contained within a display UI module. The process begins with the activation or instantiation of the UI module in the computer system [301]. At the time of instantiation the module enters a default state where either a stateless or initially selected (default) state of intent is expressed and the module remains in a passive listening mode [301]; if the module is returning to this state after a previous update process, it continues to present the current designated intent, rather than the default. The module remains in the passive mode until such time as a controlling module such as the Display Object Controller [304] activates the process of this module [303] by passing a message containing an identified intent, changing its state to an active update process. In the event that the object receives no, or no further, activation messages from the Display Object Controller (or similar) this module terminates [303] and [308]. When the module enters a active update state [332] it proceeds to look up one or more codes for the identified intent [305] in the Cod Set Data storage [307]. Note that particular embodiments will comprise one or more mode of sensory encoding and will thus look up one or more “datums” in order to facilitate the presentation of a given intent. Once the code data is retrieved the module proceeds to modify the presentation state of each applicable sensory method utilized in the embodiment for the given intent [306]. After presentation updates are complete, the module returns to the passive state [302].

FIG. 4 illustrates an exemplary sensory code record. The pictured embodiment is an associative array [401] intended to support sensory presentation for a dimensional IR system, but a variety of alternate storage implementations will be apparent to one skilled in the art. Multiple such records would comprise a collection of code set data. The array shown indicates: a unique identifier, “dimension id”; a human readable label, “dimension label;” and an RGB color value, “rgb.” This array stores the sensory code for the dimension “biology” with unique identifier “1234”, which will display the rgb color “15B80D” (i.e., a shade of green) to indicate the selection of the inference of the intent of the user to select the dimension “biology” by the input of a given display object.

FIG. 5 illustrates an alternate exemplary sensory data record that contains information for multiple presentation methods and/or modes. The pictured embodiment is an associative array [501] intended to support sensory presentation for a dimensional IR system, but a variety of alternate storage implementations will be apparent to one skilled in the art. The array shown indicates: a unique identifier, “dimension id”; a human readable label, “dimension label”; a display label, “label”; a display meaning text, “meaning”; an RGB color value, “rgb”; a font (collection of text display glyphs), “font”; a text style “style”; a text decoration, “decoration”; a sound file, “sound”; a texture image file, “texture”; the text of pronunciation guide, “pronunciation”; and unicode braille text for the label and meaning, “braille unicode label” and “braille unicode meaning”. This array stores the sensory code for the dimension “biology” with unique identifier “1234”, which in various contexts and/or modes may use one several or all of the presentation modes stored here. In order to indicate the selection of the inference of the intent of the user to select the dimension “biology” by the input of a given display object a given embodiment may: modify the label text of the display object to read “Biology”; display, or prepare for display on the basis of some other interaction, the meaning text “The study . . . ”; display the rgb color “15B80D” (i.e., a shade of green) in the context of the display object (or modify all of some part of the presentation of the object to be that color); change the font of one or more parts of text of the object to use Times New Roman glyphs; change the style of the text glyphs of one or more parts of the object to italic; changes the glyph decoration of one or more parts of the display object to underline; play, or prepare to play on the basis of some other interaction, the sound file biology.mp4; present, or prepare to present on the basis of some other interaction the pronunciation text /balj/; present the braille glyphs via an appropriate output device with generally the same behavior described for the label and meaning fields. This list of possible sensory implementations is one exemplary embodiment; to one adequately skilled in the art, other possible implementations will be understood.

Forms are typically a collection of groups of “input object groups” (or simply “input object” or “input group”) comprised of: an input element (text box, check box, radio button, selection menu, etc.); coupled with a label element (usually a text label positioned over or alongside each input element, though in some variant cases it may be conditionally within the input element); sometimes coupled with a feedback (or validation) element; and if the input object includes a fixed or static list of possible inputs, then there will be a mechanism for listing labeling and enabling the selection of one or more elements in the list, with various rules for their selection—i.e., radio buttons, menus, pick lists, etc.). Note that the idea of an input object group is distinct from “input element” which is a reference to the specific mechanism used for capturing user input, without the accompanying elements.

Typical methods of form construction fall into two categories with varying degrees of dynamic modularity and adaptability. The most common method of form construction is to include all elements in the form statically. The second typical method is to display or hide various specific input objects or sets of input objects based on the current values that have been selected or input in the visible elements: such dynamic form methods are mechanisms that are designed to decrease the cognitive load of the user. These two general categories hold true across most every type of form implementation, even those that are embodied in multi-page or multiple time intervals. There are some forms that also generate new additional input objects based on prior input or captured data. From the perspective of this disclosure, the most common attribute these extant methods share is that the role of each dynamic input object is fixed. For example, if someone enters an age over 60 year in an age field in a form, the form may respond by displaying a “Retired: yes [ ] no [ ]” radio input object that is otherwise displayed. But, the precise role played by the input object contemplated by the logic of the software behind the form is fixed: i.e., the user cannot interact with the “retired” object to change its meaning. Even in a case where the same form may also display a “In School: yes [ ] no [ ]” if the input age of the prior field was under 30 years, where the underlying software may display one or more additional fields, the specific potentially displayed fields have specifically assigned meanings and modes. For purposes of this disclosure, this quality of the input object will be referred to as its “intent.”

One example embodiment includes a collection of methods and processes that enable a high degree of dynamic modularity and adaptability with minimal cognitive load, but rely on a different method than dynamic display or hiding of input objects or sets of input objects to generate dynamic form elements. One example is also differentiated from extant methods by the fact that the role of the data as it is consumed by downstream processes or software modules is fixed by the specific input object that captured it. Most implementations eliminate the need to cast a specific datum in a specific role based solely on when or where it was entered, enabling much more flexible, simple and streamlined forms with correspondingly lower cognitive loads.

The methods and processes of the many implementations are comprised of dynamic generation of input objects comprised of: a dynamic label, a dynamic input element; and a dynamic intent; and may also incorporate additional common features of input groups such as feedback mechanisms. At least one embodiment disclosed here was originally created to support search (specifically dimensional search) applications, but has applicability in a number of form applications.

It should be noted that prior to value entry by a user the exemplary input objects may, depending on the precise implementation, be in a number of different states, including, but not limited to: stateless, defaulted to a specific intent (e.g. “term”, then refined to “text term” or “search category”, etc.), or defaulted to a generic/categorical intent (e.g. “name”, then refined to first, last etc. based on intent inference).

For the purposes of this disclosure, the term “intent inference” refers to a process of predicting the implicit intention of a user's interaction with a given input object via the input value provided. This inference is a prediction of the user's desire of how the input should be interpreted. (e.g., if the user were to enter “Kareem Abdul Jabbar”, one embodiment may infer the intent of the input object to be “basketball player”). The response of the various components of a preferred embodiment system to the inference is to record all associated attributes of the intent (including, but not limited to label, disambiguation cues and validation cues) and display in the context of the input object within the UI. After intent inference occurs in the preferred embodiment, a given input object moves into a static state. The static state represents an opportunity (either passive/explicit or prompted) for the user to react to the presented interpretation of the value that was input. The user reaction may include, but is not limited to correction, acceptance, negation, etc. of the interpretation and may occur passively, explicitly or manually.

1. A method, comprising:
selecting a potential intent based on the input of a particular value;
applying the selected intent to a given input element's data attributes;
applying the selected intent to a given input element's presentation within a UI;
applying the selected intent to the interpretation of a given element's value by a receiving or monitoring software process or module; and
applying one or more coding systems in the presentation of the selected intent.

2. The method of claim 1, wherein the selected intent is specifically selected for the purposes of selecting a dimension in an IR system.

3. The method of claim 1, wherein one or more potential intents are selected.

4. The method of claim 1, where one or more potential intents are ranked or scored.

5. The method of claim 1, wherein a given element's presentation is expressed in an input object label.

6. The method of claim 1, wherein a given element's presentation is expressed in color.

7. The method of claim 1, wherein a given element's presentation is expressed in the style or font of text of an input object label.

8. The method of claim 1, wherein a given element's presentation is expressed in sound.

9. The method of claim 1, wherein a given element's presentation is expressed in surrounding or visually associated graphical elements or icons.

10. The method of claim 1, wherein the selected intent includes a logical attribute.

11. The method of claim 1, wherein the selected intent includes the expression of a logical dimension.

12. The method of claim 1, wherein the selected intent may be tacitly or implicitly accepted by a user.
